(19) United States
(12) Patent Application Publication
(10) Pub. No.: US 2025/0158550 A1
(43) Pub. Date: May 15, 2025

(54) PROGRAMMABLE HAPTIC FEEDBACK INDUSTRIAL PADDLE SWITCH FOR OPERATING A MOTOR CONTROLLED DEVICE

(71) Applicant: Hubbell Incorporated, Shelton, CT (US)

(72) Inventors: Jeffrey Turner Reid, Sinking Spring, PA (US); Roger William Deihm, Mohnton, PA (US); Joe Albert Uhl, JR., Boyertown, PA (US); John Victor Zukas, Zionville, PA (US)

(21) Appl. No.: 18/941,614

(22) Filed: Nov. 8, 2024

Related U.S. Application Data
(60) Provisional application No. 63/597,773, filed on Nov. 10, 2023.
(60) Provisional application No. 63/597,778, filed on Nov. 10, 2023.

(51) Int. Cl. H02P 23/00; H02P 25/032

(52) U.S. Cl. CPC H02P 23/00; H02P 25/032

(57) ABSTRACT

A programmable sensory feedback switch (e.g., implemented as a programmable haptic feedback fingertip paddle switch) is configured to operate a vibration motor to provide haptic feedback for different switch positions and different motor controlled device conditions, and to operate as a new 11-point detented switch, among other switch functions, and is also capable of operation in Harsh Areas (HA). This new programmable sensory feedback switch is configured to provide users (e.g., transmitter operators in a radio control system for mobile equipment such as cranes) the ability to feel haptic feedback at the switch at different programmed virtual detents or switch positions, or in association with different conditions (e.g., speed control for as many as 5 speeds, position of the switch, or position or status of motor controlled device), even in industrial environments where the operator is wearing thick protective gloves that can hinder the operator's perception of external tactile inputs.

This application claims the benefit of U.S. Provisional Patent Application Ser. No. 63/597,773, filed on Nov. 10, 2023, and U.S. Provisional Patent Application Ser. No. 63/597,778, filed on Nov. 10, 2023, which are hereby incorporated herein by reference in their entireties.

### BACKGROUND

### Field

Example embodiments of the present disclosure generally relate to a programmable device and method to provide operator sensory feedback for a controller of a motor controlled device (e.g., a controller or transmitter in a radio crane control system) utilizing an industrial paddle switch for speed and location control of the motor controlled device relative to paddle switch position. More specifically, in accordance with example embodiments of the present disclosure, a programmable sensory feedback switch (e.g., a programmable haptic feedback fingertip paddle switch) is provided that can be configured to vary operation of a vibration motor therein depending on various conditions, or operate as a new 11-point detented switch, among other switch functions, and is also capable of operation in Harsh Areas (HA).

### Description of Related Art

Existing controllers of industrial motor controlled equipment can have one or more paddle switches that an operator moves to control a motor controlled device (e.g., a crane) in a desired manner that depends on the position of the paddle switch as it is moved by the operator. Existing controllers of industrial motor controlled devices generally can provide a method of sensory feedback which utilizes fixed mechanical detents within the paddle switch to provide paddle switch positional data relative to a starting position thereof.

Mobile equipment controller operators struggle with existing switches provided on controllers because different physical switches with different detents are needed for various crane control motor speeds (e.g., 4 speed, 3 speed, 2 speed). This requires manufacturers to offer different controllers to accommodate various controlled device applications, which complicates production and inventory for the manufacturers as well as complicates design, acquisition of parts and maintenance of motor control systems for system designers and operators. Also, existing switches provided on controllers do not provide the desired amount of haptic feedback to controller operators.

### SUMMARY

A need exists for a versatile industrial paddle switch for a motor controlled device that is programmable to provide control of 2 through 5 speeds, as well as provide virtual detents other switch control functions used for motor controlled devices while also providing haptic feedback to the paddle switch operator.

The above and other problems are overcome, and additional advantages are realized, by illustrative embodiments.

An illustrative embodiment of the present disclosure provides a programmable sensory feedback switch to control a motorized device comprising: a user moveable control interface chosen from a knob, a lever, and a paddle switch, and configured to be manually touched by the user and moved along at least one axis thereof by a designated amount to control the motorized device; at least one electronic sensor to detect movement of the user moveable control interface when manipulated by the user and to generate voltage outputs based on detected position of the user moveable control interface; a vibration motor disposed proximally to the user moveable control interface; and a switch operational software program executed by a programmable processor to generate vibration motor control signals that produce vibrations in one or more designated patterns based on detected position of the user moveable control interface and corresponding control commands for the motorized device to provide haptic vibration feedback to the user.

In accordance with aspects of illustrative embodiments, the programmable sensory feedback switch further comprises a molded handle that covers the user moveable control interface and is shaped to provide the user with an ergonomic grip.

In accordance with aspects of illustrative embodiments, the vibration motor is disposed within the handle and proximal to at least a portion of the ergonomic grip.

In accordance with aspects of illustrative embodiments, the at least one electronic sensor is a Hall effect sensor.

In accordance with aspects of illustrative embodiments, the processor is disposed at a location chosen from inside a housing for the at least one electronic sensor provided in the programmable sensory feedback switch, inside a molded handle that covers the user moveable control interface, and separate from programmable sensory feedback switch.

Another illustrative embodiment of the present disclosure provides a kit comprising a transmitter having a console and at least one programmable sensory feedback switch according to the above referenced illustrative embodiment disposed on the console, and a receiver associated with the motor controlled device and configured to communicate with the transmitter, the transmitter configured to map the voltage outputs from the programmable sensory feedback switch into the control commands to command selected operations of a motor in the motor controlled device and to send the control commands to the receiver to provide the control commands to the motor controlled device, the switch operational software program executed by the programmable processor being operable to generate the vibration motor control signals based on the control commands transmitted to the receiver.

In accordance with aspects of illustrative embodiments, the switch operational software program executed by the programmable processor being operable to generate the vibration motor control signals based also on status of the motor controlled device as indicated in reply signals sent to the transmitter by the receiver.

In accordance with aspects of illustrative embodiments, the kit comprises a plurality of console switches comprising a plurality of the programmable sensory feedback switch according to claim 1 disposed on the console.

In accordance with aspects of illustrative embodiments, the plurality of console switches are configured to operate respective motor controlled devices.

In accordance with aspects of illustrative embodiments, the respective motor controlled devices are deployed on a crane.

In accordance with aspects of illustrative embodiments, at least one of the respective motor controlled devices is operable with five speeds, and the switch operational software program executed by the programmable processor is operable to generate the vibration motor control signals to vary according to respective ones of the five speeds as selected via corresponding detected positions of the user moveable control interface.

In accordance with aspects of illustrative embodiments, the receiver can transmit reply signals to the transmitter that comprise device data related to the motor controller device chosen from position of the motor controlled device, status of operation of the motor controlled device, speed of movement of the motor controlled device, wherein the switch operational software program executed by the programmable processor is operable to analyze the device data in the reply signals and generate the vibration motor control signals to provide haptic signals that vary in accordance with the device data.

In accordance with aspects of illustrative embodiments, the vibration motor operates with increasing intensity of vibration as the motor controlled device reaches a designated positon as indicated in the reply signals.

In accordance with aspects of illustrative embodiments, the vibration motor is controlled via the vibration motor control signals to change vibration to indicate that a fault condition has occurred with respect to at least one of the receiver and the motor controlled device, the fault condition chosen from the transmitter and the receiver are not connected, the receiver and/or the motor controlled device has malfunctioned, and the motor controlled device has lost power.

In accordance with aspects of illustrative embodiments, the at least one programmable sensory feedback switch according to claim 1 is configured via the switch operational software program executed by the programmable processor to have a user designated number of virtual detents wherein the vibration motor generates a vibrational haptic feedback as the user manipulates the user moveable control interface into a position corresponding to one of the virtual detents.

Additional and/or other aspects and advantages of illustrative embodiments will be set forth in the description that follows, or will be apparent from the description, or may be learned by practice of the illustrative embodiments. The illustrative embodiments may comprise apparatuses and methods for operating same having one or more of the above aspects, and/or one or more of the features and combinations thereof. The illustrative embodiments may comprise one or more of the features and/or combinations of the above aspects as recited, for example, in the attached claims.

### BRIEF DESCRIPTION OF THE DRAWINGS

The above and/or other aspects and advantages of the illustrative embodiments will be more readily appreciated from the following detailed description, taken in conjunction with the accompanying drawings.

FIG. 1 depicts a programmable sensory feedback switch constructed in accordance with an example embodiment of the present disclosure.

FIG. 2 is an example radio control system for radio-controlled machine (RCM) devices having a transmitter on which a programmable sensory feedback switch constructed in accordance with example embodiments of the present disclosure can be deployed.

FIG. 3A is an example transmitter/controller on which a programmable sensory feedback switch constructed in accordance with example embodiments of the present disclosure can be deployed.

FIG. 3B is a block diagram of the transmitter/controller in FIG. 3A.

FIGS. 4A and 4B are, respectively, right side isometric assembled and exploded views of a programmable sensory feedback switch constructed in accordance with an example embodiment of the present disclosure and shown without an optional control printed circuit board assembly (PCBA).

FIGS. 5A and 5B are, respectively, left side isometric assembled and exploded views of a programmable sensory feedback switch constructed in accordance with an example embodiment of the present disclosure and shown with an optional control printed circuit board assembly (PCBA).

FIGS. 5C, 5D and 5E are, respectively, front, top and bottom views of the programmable sensory feedback switch shown in FIGS. 5A and 5B.

FIGS. 5F and 5G are, respectively, right side cross-section and partial perspective views of the programmable sensory feedback switch shown in FIGS. 5A and 5B.

FIGS. 6A and 6B illustrate an example mapping of switch input movement to output voltage characteristics that can be implemented in a programmable sensory feedback switch constructed in accordance with examples embodiment of the present disclosure.

FIG. 7 illustrates a programmable sensory feedback switch providing continuous variable vibration depending on the degree to which the operator moves the switch a selected number of degrees along an operational axis of the switch in accordance with an example embodiment of the present disclosure.

FIG. 8 illustrates a programmable sensory feedback switch providing virtual detents in accordance with an example embodiment of the present disclosure.

Throughout the drawing figures, like reference numbers will be understood to refer to like elements, features and structures.

### DETAILED DESCRIPTION OF ILLUSTRATIVE EMBODIMENTS

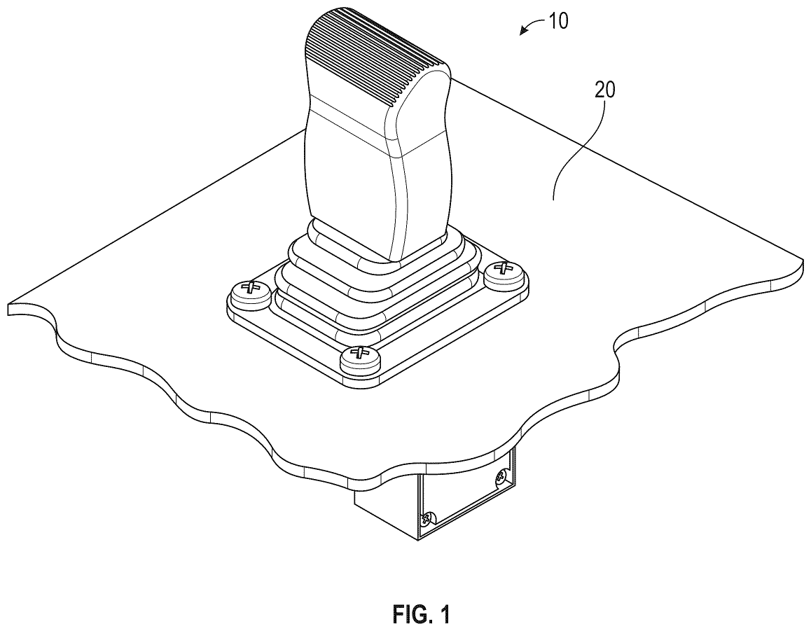

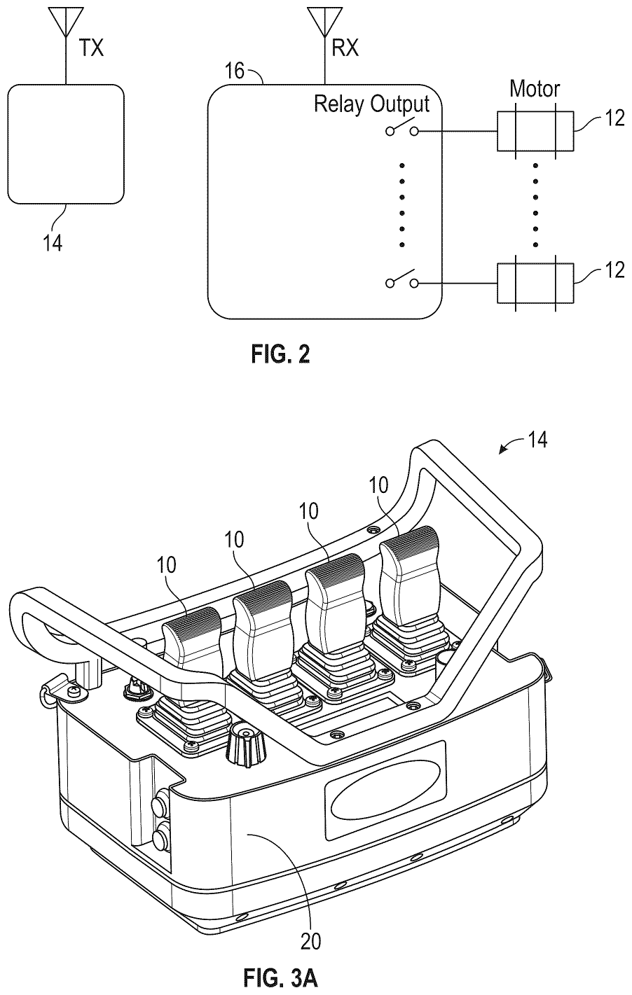

FIG. 1 depicts a programmable sensory feedback switch 10 constructed in accordance with an example embodiment of the present disclosure. The programmable sensory feedback switch 10 as described herein can be used in a controller 14 for motor controlled equipment 12. For example, as shown in FIG. 2, the programmable sensory feedback switch 10 can be deployed on a console 20 of a transmitter 14 that sends control signals to a receiver 16 based on operation of the switch 10. The receiver 16, in turn, operates a motor of the motor controlled device 12 based on the control signals. The control system shown in FIG. 2 is a radio control system. It is to be understood, however, that the transmitter/controller 14 having the switch 10 can be hardwired to the motor controlled equipment 12 to operate a motor associated therewith in accordance with outputs from the switch 10.

With continued reference to FIGS. 1 and 2 and in accordance with example embodiments of the present disclosure, a programmable sensory feedback switch 10 (e.g., a programmable haptic feedback fingertip paddle switch) is provided that can be configured to operate a vibration motor to provide haptic feedback for different switch 10 positions and different motor controlled device 12 conditions, and to operate as a new 11-point detented switch 10, among other switch functions, and is also capable of operation in Harsh Areas (HA). This new programmable sensory feedback switch 10 is configured to provide users (e.g., transmitter 14 operators in a radio control system for mobile equipment 12 such as cranes) the ability to feel haptic feedback at the switch 10 at different programmed virtual detents or switch positions, or in association with different conditions (e.g., speed control for as many as 5 speeds, position of the switch 10, or position or status of motor controlled device 12), even in industrial environments where the operator is wearing thick protective gloves that can hinder the operator's perception of external tactile inputs. This new programmable sensory feedback switch 10 provides many advantages over conventional paddle switches (e.g., paddle switches on belly box-type radio control system transmitters) that cannot withstand harsh environments, or cannot provide the operational feel that users want and need when controlling a Radio-Controlled Machine (RCM) device 12 such as a crane or other mobile equipment (e.g., particularly in industrial environments where users are wearing protective gloves that impair fingertip sensations while operating a switch).

Reference is also made to the co-pending application entitled “Remote Radio Control System for Cranes and Other Mobile Equipment” filed concurrently herewith, which is incorporated herein by reference in its entirety, and which discloses a platform for an improved radio control system for mobile equipment (e.g., crane) that has different types of Transmitters 14 (Basic Transmitter, Standard Transmitter, Belly Box Transmitter, and Mill-Style Belly Box Transmitter) and different types of Receivers 12 (Standard Crane Mount Receiver, Digital Receiver, Expandable Receiver operable with different internal expansion cards, and different external Receiver boards) from which users can create a customized radio system for their desired RCM (e.g., a DC Radio System, or an AC Radio System, for industrial and commercial environments). The programmable sensory feedback switch 10 can be provided on the Belly Box Transmitter and the Mill-Style Belly Box Transmitter, for example. Example embodiments of a programmable sensory feedback switch 10 are described herein in use with respect to controlling crane operations; however, it is to be understood that the programmable sensory feedback switch 10 can be used with other types of motor controlled devices 12 and in other applications and environments (e.g., mobile chair control, control of mobile equipment used by railroads and at construction sites, and so on).

In accordance with example embodiments of the present disclosure, a programmable sensory feedback switch 10 is provided that is implemented as a paddle switch (e.g., a paddle switch mounted on an industrial controller 14 console 20 such as a belly box-style transmitter in a radio control system for a RCM device 12) that utilizes haptic sensory feedback to provide sensory data to the operator of the programmable sensory feedback switch 10 in various scenarios and in accordance with different example methods. It is to be understood that other different form factors for the switch 10 can be used such as, but not limited to, a lever, a knob, a rocker switch, a sliding switch, a rotating switch, among others. As described below, the form factor of switch 10 preferably accommodates a vibration motor 46 therein, or at least proximal to the switch, to impart a vibrational haptic feedback to the user who is manually manipulating the switch 10.

In accordance with an example Method A, haptic sensory feedback (e.g., vibrational feedback) is programmed into the programmable sensory feedback switch 10 to provide variable vibration feedback intensity (e.g., vibration increasing or decreasing in intensity relative to a selected condition) into a fingertip paddle switch implementation of the a programmable sensory feedback switch 10. For example, the variable feedback intensity can be an increase or decrease in vibration intensity that changes relative to one of the following example conditions:
a) relative to the position of the paddle switch 10 based on its starting position on a console of a controller or transmitter 14;
b) relative to speed of the controlled device 12 (e.g., the RCM device);
c) relative to position of the controlled device 12; or
d) relative to operational status of the controlled device 12.
   In accordance with an example Method B, haptic sensory feedback (e.g., vibrational feedback) is programmed into the programmable sensory feedback switch 10 to provide variable virtual detents (e.g., vibrational bursts or other haptic feedback method to create virtual “button click” sensations) to demark respective designated positions of the paddle switch 10 for location control and feedback relative to its starting position.

In accordance with an example embodiment of the present disclosure, a programmable sensory feedback switch 10 comprises an industrial fingertip paddle switch having an internal micro vibration motor 46 that provides sensory feedback to the switch 10 operator based on a switch operation software program that implements an example embodiment method.

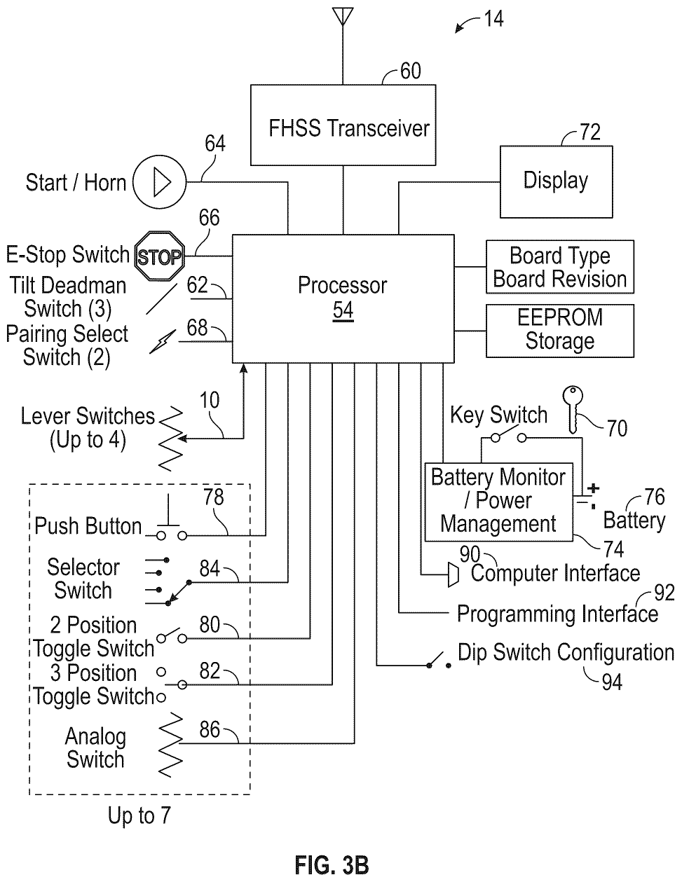

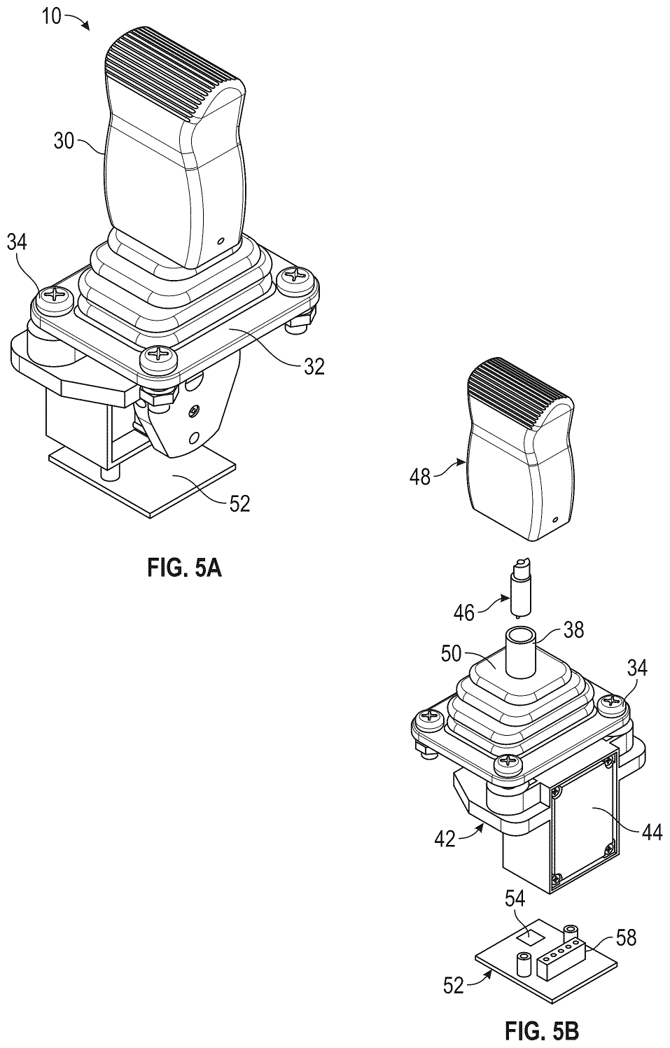

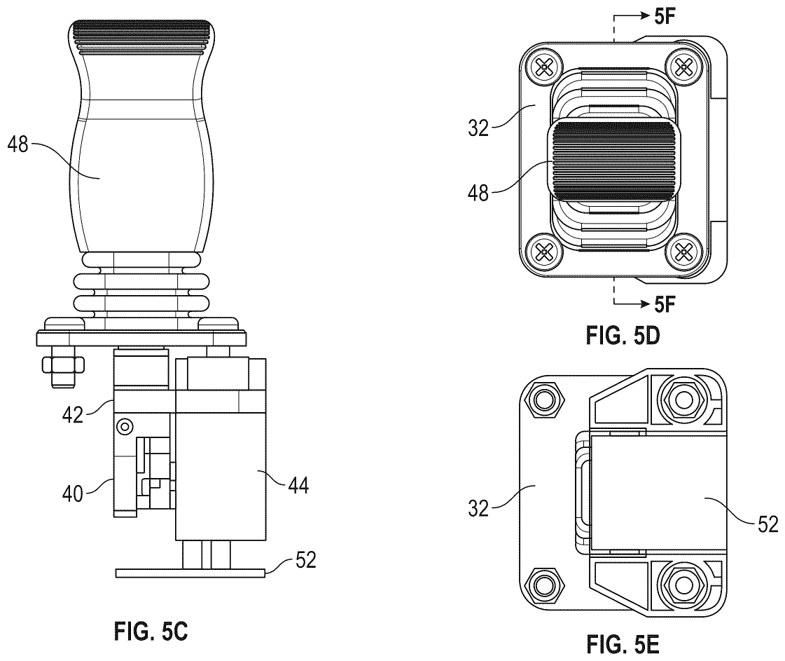

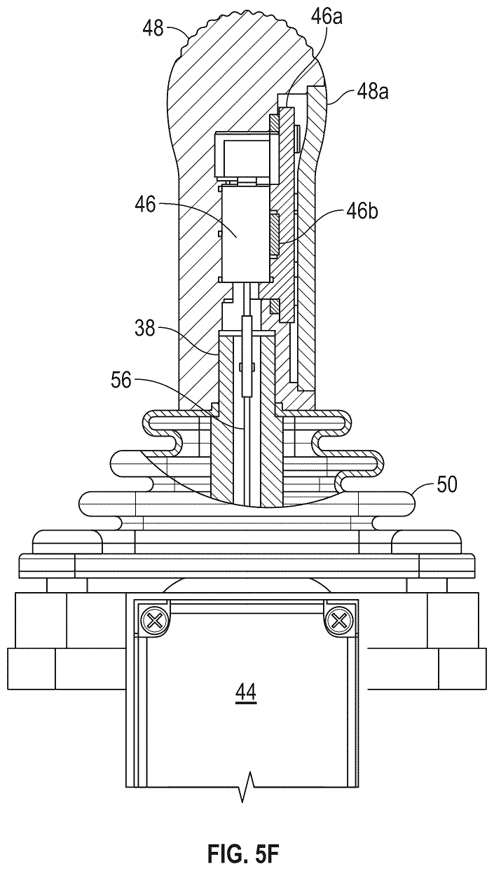

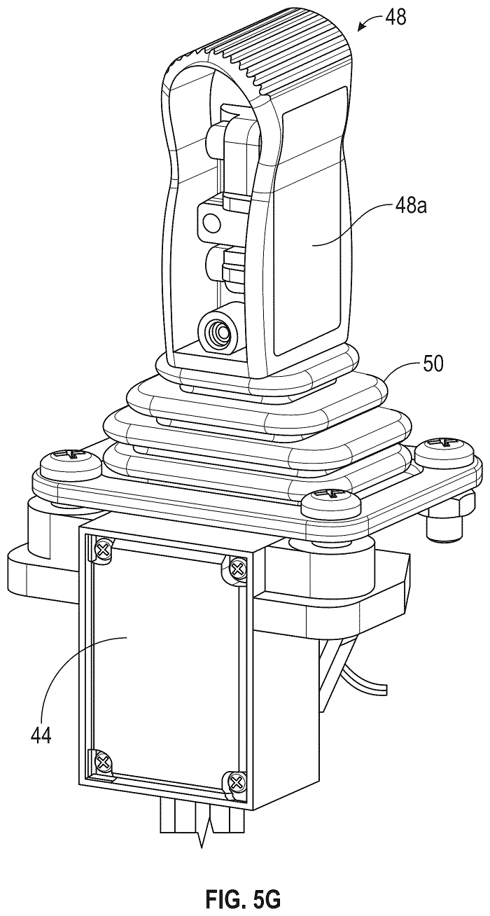

The switch operation software program is utilized by a processor 54 associated with the paddle switch 10. It is to be understood that the processor 54 operating in accordance with the switch operation software program can be provided in the paddle switch 10 or separate therefrom. For example, the paddle switch 10 can be provided with a printed circuit board assembly (PCBA) 52 having a processor 54 (FIG. 5B). The PCBA 52 can be integrated in the paddle switch 10, or provided as an optional component 52. Alternatively, the switch operation software program can be executed by a processor 54 that is associated with a controller 14, as illustrated in FIG. 3B. For example, FIG. 3A illustrates an example belly box-style transmitter/controller 14 for operating a crane in a radio crane control system. The belly box-style transmitter/controller 14 has a console 20 on which four of the paddle switches 10 are mounted. Although this illustrated belly box-style transmitter/controller 14 contains four paddle switches for descriptive purposes, it is to be understood that other such controllers 14 can contain two to seven paddle switches and that larger Mill Style-belly boxes 14 allow for an even higher quantity of switches 10. FIG. 3B is a block diagram for the belly box-style transmitter/controller 14 comprising a processor 54 that is programmed to operate the various components shown, including four lever switches that each can be a programmable sensory feedback switch 10 implemented as an industrial fingertip paddle switch in accordance with example embodiments. FIG. 3B is described in more detail below.

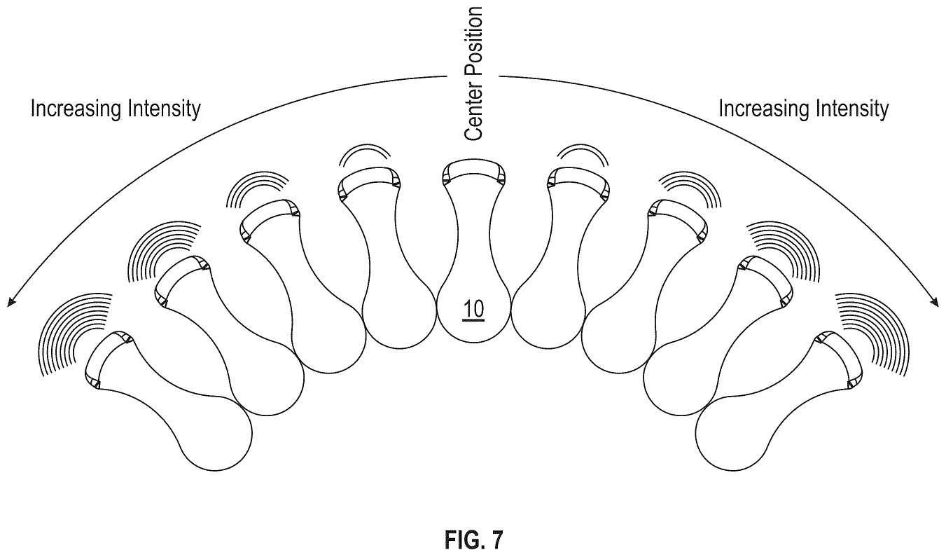

The switch operational software program can implement the above-referenced Method “A” wherein the programmable sensory feedback switch 10 implemented as an industrial fingertip paddle switch 10 provides continuous sensory input to an operator of the programmable sensory feedback switch 10, thereby providing an additional amount of operational control and understanding as to the status of controlled device. FIG. 7 illustrates, for example, continuous variable vibration depending on the degree to which the operator moves the paddle switch a selected number of degrees along an operational axis of the paddle switch.

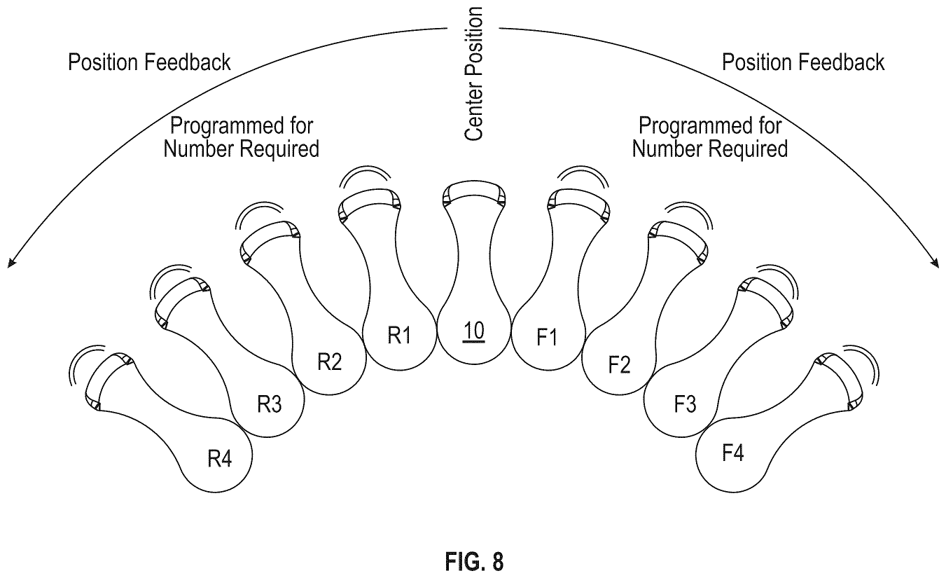

The switch operational software program can implement the above-referenced Method “B” wherein an unlimited variable number of virtual detents in both directions of operation can be programmed into the programmable sensory feedback switch 10. For example, FIG. 8 illustrates a programmable sensory feedback switch 10 implemented as an industrial fingertip paddle switch that operates using four virtual detents in each of two directions (e.g., operating motorized crane movement front and back). The vibration motor 46 provided in the switch 10 can be operated in accordance with the switch operational software program to briefly vibrate with the position of the switch 10 as it is detected to have been moved by a user into one of the respective locations of desired virtual detents.

As described below, the sensed positions of the switch 10 can be provided to a processor 54 provided at the switch 10 or at a transmitter/controller 14 associated with the switch 10 and, in turn, mapped to a particular control action of a motor controlled device 12 that is transmitted to a receiver 16 associated with the motor controlled device 12. For example, the corresponding actions of the motor controlled device 12 desired by moving the switch 10 into the various virtual detent positions can be selection among speeds 1 through 4 of movement of the motor controlled device to the rear (e.g., rearward movement speeds R1 through R4, or frontward movement speeds F1 through F4). As stated above, some control systems for motor controlled devices 12 such as cranes require a fifth speed (e.g., for tilt). The actual maximum number of speeds may be less than or greater than five, based on customer specific requirements. A standard belly box controller 14, for example, has five speeds in both directions. The programmable sensory feedback switch 10 is advantageous because five virtual detents, or other number of virtual detents, can be programmed via the switch operational software program with convenience and versatility for the user, which is an advantageous feature that is not provided by existing industrial paddle switches.

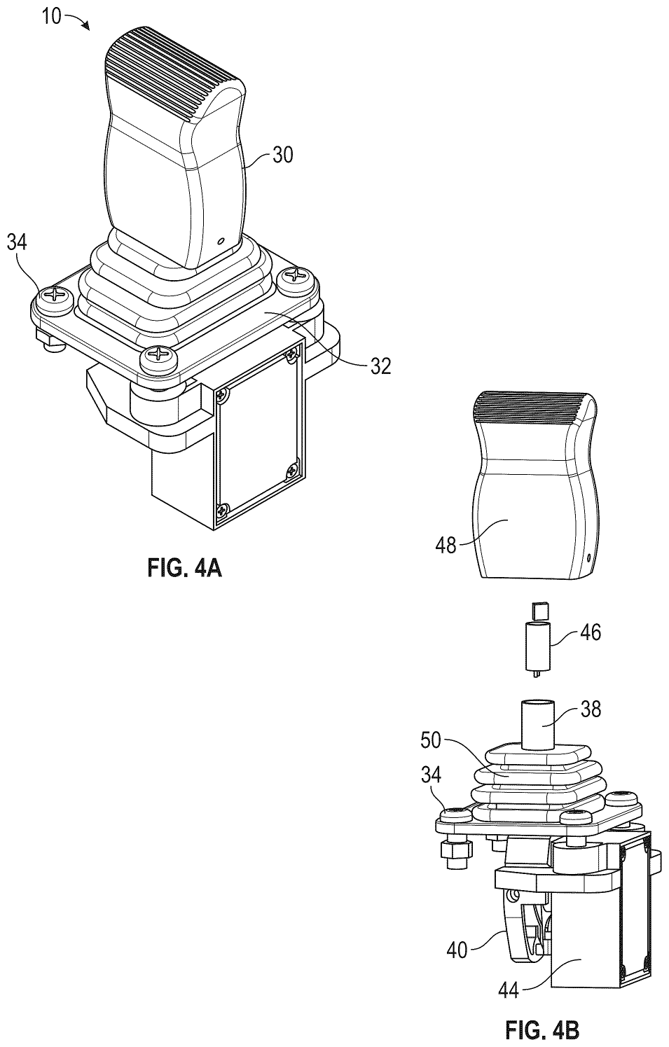

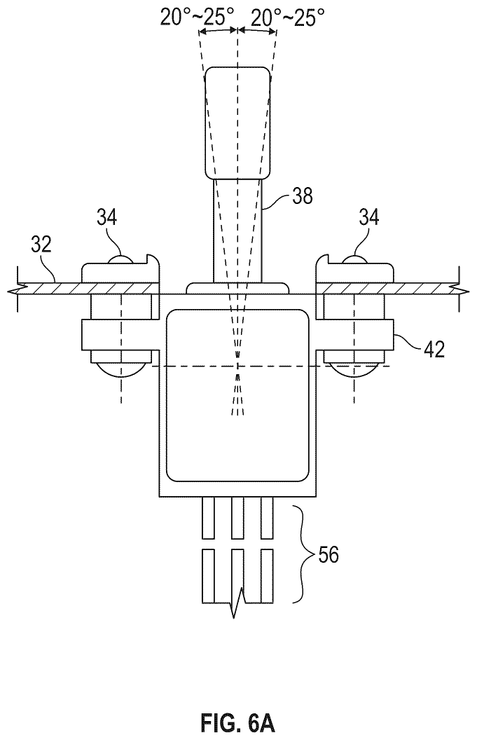

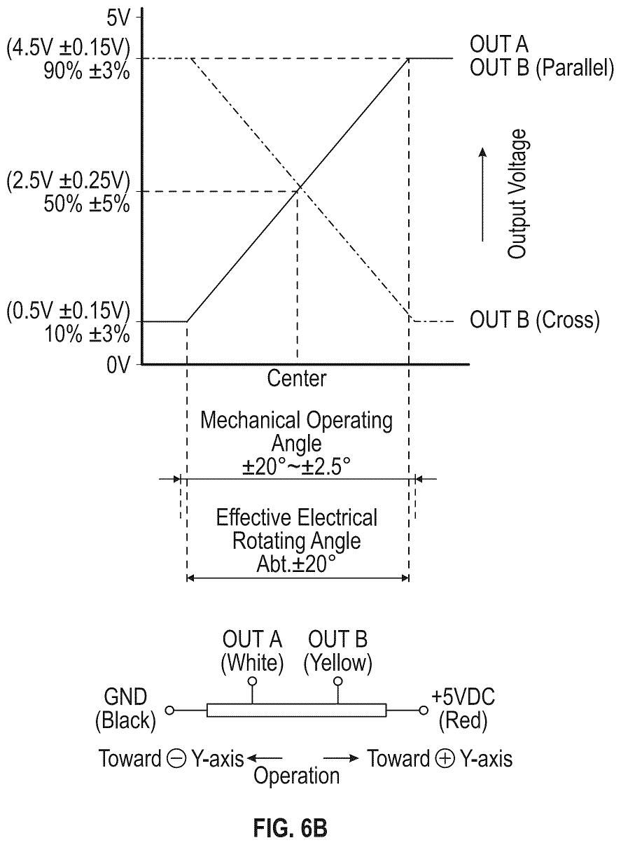

An example implementation of a programmable sensory feedback switch 10 is shown in FIGS. 4A through 5G. The programmable sensory feedback switch 10 in FIGS. 5A through 5G is provided with an optional PCBA 52, whereas the programmable sensory feedback switch 10 in FIGS. 4A and 4B is shown without the optional PCBA 52. With the exception of the optional PCBA 52, the components in the programmable sensory feedback switch 10 shown in FIGS. 4A through 5G are basically the same. In accordance with an example embodiment, a programmable sensory feedback switch 10 comprises a switch assembly 30 extending from a mounting plate 32 that can be secured to a surface (e.g., the instrument panel side or top of a console 20) with fixing screws 34. The switch assembly 30 has a handle 48 connected to a distal end of an activation post or lever 38 that is coupled to activation cams 40 or other mechanism that cooperate with a sensor(s) 42 such as a Hall effect sensor disposed within an electronics housing 44. The sensor(s) 42 determines post or lever 38 position as it is manipulated by a user and generates a corresponding output voltage based on output voltage characteristics of the sensor(s). For example, the sensor(s) 42 can operate similarly to that used in the JL30H-XI-10R1GH paddle switch controller that is commercially available from P3 America, Inc. in Leander, Texas. FIGS. 6A and 6B illustrate an example mapping of switch input movement to output voltage characteristics available from the JL30H-XI-10R1GH paddle switch controller that also can be implemented in a programmable sensory feedback switch 10 having a Hall effect sensor 42 similar in accordance with examples embodiment of the present disclosure. For example, the programmable sensory feedback switch 10 implemented as an industrial fingertip paddle switch can be similar to a JL30H series single axis, Hall effect paddle switch in terms of having directional micro-switch options whereby an electrical travel of plus or minus 20 degrees from center or approximately 40 degrees of motion range translates to output voltage characteristics as shown in FIG. 6B. It is to be understood that the programmable sensory feedback switch 10 can be programmed to operate using different degrees of single axis or double axes movement and even rotational movement, depending on the application of the motor controlled device 12 that the switch 10 is being configured to control.

The programmable sensory feedback switch 10 further comprises a vibration motor 46. In accordance with advantageous aspects of example embodiments of the present disclosure, operation of the vibration motor 46 can vary depending on lever 38 positional manipulation by a user as determined by the sensor(s) 42 and/or other conditions such as status of the motor controlled device 12 and the type of feedback (patterns of vibration bursts and/or continuous vibration of varying intensity) desired by a user. The operation of the vibration motor 46 is controlled by the above-mentioned switch operational software program executed by a processor 54. FIGS. 6A and 6B show example lead wires 56 from a sensor in an example paddle switch that can also be used in the programmable sensory feedback switch 10 to provide electrical connection with the sensor(s) 42 and the vibration motor 46 to receive outputs from the sensor(s) 42, to provide vibration control signals to the vibration motor 46 and, if necessary, provide power to the sensor(s) 42 and/or the vibration motor 46. If an optional PCBA 52 is used with the programmable sensory feedback switch 10, the PCBA 52 can be provided with an electrical connector 58 for receiving from and providing signals to components (e.g., the sensor(s) 42 and/or the vibration motor 46) in the switch 10. As stated above, the PCBA 52 can be provided with a processor 54 that executes the switch operational software program, or a processor 54 in the transmitter/controller 14 can be used to execute the switch operational software program as illustrated in FIG. 3B.

The movement of the lever 38 of the switch 10 is translated to control signals for the motor controlled device 12 using control system software in, for example, the transmitter/controller 14. The programmable sensory feedback switch 10 further comprises the switch operational software program, which can control vibration of the switch depending on the movement of the lever 38, on the location of the motor controlled device being controlled by the switch 10, on operational status of the motor controlled device 12 being controlled by the switch 10, among other factors. For example, the control system in which a transmitter 14 having one or more of the switch 10 can receive status signals from the motor controlled device 12 that can be taken into consideration by the switch operational software program when determining one or more of frequency, amplitude, duty cycle and/or other characteristics for operating the vibration motor 46 to produce a pattern(s) of haptic or vibrational feedback (e.g., vibration motor intensity, duration, and timing) to a user depending on the operational conditions of the lever 38 and/or the motor controlled device 12. For example, as described in the above-mentioned co-pending application entitled “Remote Radio Control System for Cranes and Other Mobile Equipment,” a transmitter/controller 14 with at least one switch 10 can receive feedback from a receiver 16 (e.g., via bi-directional signals) such as outputs from the motor controlled device 12 (e.g., a crane motor) operated via the switch 10, or status updates such as loss of communication). The switch 10 on the transmitter/controller 14, in turn, is programmed to vibrate its vibration motor 46 depending on the different factors used by the switch operational software program to determine how and when to provide haptic vibrational feedback via the switch 10. It is to be understood, for example, that different patterns of vibrational haptic feedback can be produced by the vibration motor 46 in accordance with the switch operational software program besides the patterns illustrated in FIGS. 7 and 8.

With continued reference to FIGS. 4A through 5E, the programmable sensory feedback switch 10 can comprise an ergonomic shroud on the handle 48. The handle can be dimensioned to accommodate the vibration motor 46. Alternatively, the handle 48 can be configured to accommodate the vibration motor 46. In either implementation, the vibration motor 46 is disposed adjacent to or at least proximal to the distal end of the lever 38 in the handle 48 with shroud to increase the haptic feedback sensations provided to the user by the vibration motor 46. The programmable sensory feedback switch 10 also comprises an optional rubber boot 50 to protect electronics (e.g., sensor(s) 42) and activation cams 40 or other mechanism that reflects movements of the lever 38 to the sensor(s) 42 from debris and other environmental conditions.

With reference to the block diagram of the transmitter/controller 14 in FIG. 3B, the Belly Box Transmitter has a processor 54 and a transceiver module 60. The transceiver module has a built-in antenna to prevent damage and to provide adequate support is provided to ensure the antenna does not separate from the transceiver during severe shock loading. For safety reasons, the Belly Box Transmitter 14 is provided with a Tilt Switch 62 (e.g., two pendulum switches that are mounted inside the Transmitter) that can disable the Transmitter 14 when the Transmitter is tipped 30° from normal front to back position or from side to side beyond an acceptable level position. The Belly Box Transmitter 14 is further provided with a Deadman Switch such as a SPST momentary pushbutton or actuator bar that must be maintained to enable operation. The Belly Box Transmitter has a Battery Monitor/Power Management circuit 74 and one or more batteries 72.

With reference to FIG. 3B, the Belly Box Transmitter 14 has a standard set of controls for crane operation, for example:
One Side-mounted Start/Horn button 64 to initiate operation of the crane;
One Emergency Stop Twist Lock button 66 to terminate operation of the crane;
Two Side Mounted Pairing switches 68 to link the belly box to a receiver 16;
One Side Mounted Removable Key Switch 70 to Power the belly box; and
One Display 72 to convey crane operation to the operator.

These Buttons are also used for self-diagnostics of the Belly Box Transmitter, such as stuck or open button contacts. The display provides detailed information to the operator such as, but no limited to, Motion/Speed Indication, Function Activation, Maintenance Mode/diagnostics, Overall battery Status, Pairing Selections, Currently Paired Device Name, E-Stop Activation, and Tilt Warning.

With continued reference to FIG. 3B, the Belly Box Transmitter has up to four bidirectional spring-to-center Lever Switches (e.g., programmable sensory feedback switches 10) with up to 11 programmable lever status indications such as:
Vibration at Transition—The lever willcan vibrate momentarily at the transition between speeds. The indication of the speed is also on the display.
Vibration at Speed—The lever willcan vibrate at a predetermine rate at each defined speed. The higher speed the increase in vibration amplitude. The indication of the speed is also on the display.
None—The lever has no vibration. The indication of the speed is only on the display.

The Belly Box Transmitter 14 can have configurable operators based on Customer requirements and application including the following Switch Configurator positions: Paddle switch Position PSW1; Paddle switch Position PSW2; Paddle switch Position PSW3; Paddle switch Position PSW4; Operator Position A1; Operator Position A2; Operator Position B1; Operator Position B2; Operator Position B3; Operator Position B4; and Operator Position B5.

As shown in FIG. 3B, the Belly Box Transmitter 14 can be operated with up to seven Auxiliary Switches including, but not limited to, a Pushbutton Switch 78, a Two Position Toggle Switch 80, a Three Position Toggle Switch, a two through ten configurable Selector Switch 84, and an Analog Switch 86. To implement the different functions, the Transmitter 14 has a computer interface 90 or other programming interface 92 to configure the Transmitter 14 (e.g., a radio controlled machine (RCM) Interface Software can be employed to convey information to the processor 54 to correctly configure the signals via the programming interface 92). The Belly Box Transmitter 14 also has a DIP switch 94 setting array accessible through a battery compartment on the Transmitter 14, for example, to configure unique settings to the Transmitter such as, but not limited to, Inactivity Time Selection, Tilt Switch Activation, and Deadman Activation. The Belly Box Transmitter is factory configured by customer request with the correct number and type of switches required by the radio control system. The Transmitter arrangement of levers/switches/buttons can be custom based on the customers' needs and, as such, a custom configuration is loaded into each one. The Transmitter 14 can be modified by a system user with the RCM Interface Software. The Transmitter/Receiver pair configuration and logs can be also accessed using the RCM Interface Software, for example.

While the programmable sensory feedback switch 10 can be programmed via the switch operational software program to have virtual detents, the switch 10 also generates haptic feedback for virtual detent notifications that are particularly useful in harsh or hazardous areas or environments wherein users are wearing thick, bulky protective gear such as metal clad founding gloves that would normally prevent users from feeling virtual detents but for the vibrations generated by the vibration motor 46. The switch operational software program also advantageously generates patterns of vibrations with intermittent vibrations to reduce the possibility of the user's hand that controls the switch 10 from becoming numb, which can happen if constant haptic vibrations are used.

In a non-limiting example, the programmable sensory feedback switch 10 is implemented as a Hall effect haptic feedback industrial fingertip paddle switch that is sealed to a achieve a IP65 water resistant rating. The switch 10 is provided with an embedded internal micro vibration motor 46 (e.g., a #306-109.006 type motor available from Precision Microdrives, or equivalent) to provide the sensory feedback to a user of the switch. The customized switch 10 can be implemented using, for example, a modified JL30H-XI-10R1GH paddle switch controller having vibration motor 46 internally secured within a custom designed injection molded paddle comprising the handle 48. The switch 10 design can include a custom on board control printed circuit board 52 for controlling the vibration motor 46 intensity, duration, and timing using the switch operational software program providing in accordance with example embodiments. Alternatively, the switch 10 design provides separate vibration motor 46 and switch 10 operation connection points (e.g., via wire harnesses or connectors) that can be utilized for direct control by another printed circuit board.

It will be understood by one skilled in the art that this disclosure is not limited in its application to the details of construction and the arrangement of components set forth in the above description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented, for example, as a computer program product such as a computer program, program code or computer instructions tangibly embodied in an information carrier, or in a machine-readable storage device, for execution by, or to control the operation of, data processing apparatus such as a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the illustrative embodiments can be easily construed as within the scope of claims exemplified by the illustrative embodiments by programmers skilled in the art to which the illustrative embodiments pertain. Method steps associated with the illustrative embodiments can be performed by one or more programmable processors executing a computer program, code or instructions to perform functions (e.g., by operating on input data and/or generating an output). Method steps can also be performed by, and apparatus of the illustrative embodiments can be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In other words, the processor and the storage medium may reside in an integrated circuit or be implemented as discrete components.

Computer-readable non-transitory media includes all types of computer readable media, including magnetic storage media, optical storage media, flash media and solid state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

The above-presented description and figures are intended by way of example only and are not intended to limit the illustrative embodiments in any way except as set forth in the following claims. It is particularly noted that persons skilled in the art can readily combine the various technical aspects of the various elements of the various illustrative embodiments that have been described above in numerous other ways, all of which are considered to be within the scope of the claims.

1. A programmable sensory feedback switch to control a motorized device comprising:
a user moveable control interface chosen from a a knob, a lever, and a paddle switch, and configured to be manually touched by the user and moved along at least one axis thereof by a designated amount to control the motorized device;
at least one electronic sensor to detect movement of the user moveable control interface when manipulated by the user and to generate voltage outputs based on detected position of the user moveable control interface;
a vibration motor disposed proximally to the user moveable control interface; and
a switch operational software program executed by a programmable processor to generate vibration motor control signals that produce vibrations in one or more designated patterns based on detected position of the user moveable control interface and corresponding control commands for the motorized device to provide haptic vibration feedback to the user.

2. The programmable sensory feedback switch of claim 1, further comprising a molded handle that covers the user moveable control interface and is shaped to provide the user with an ergonomic grip.

3. The programmable sensory feedback switch of claim 1, wherein the vibration motor is disposed within the handle and proximal to at least a portion of the ergonomic grip.

4. The programmable sensory feedback switch of claim 1, wherein the at least one electronic sensor is a Hall effect sensor.

5. The programmable sensory feedback switch of claim 1, wherein the processor is disposed at a location chosen from inside a housing for the at least one electronic sensor provided in the programmable sensory feedback switch, inside a molded handle that covers the user moveable control interface, and separate from programmable sensory feedback switch.

6. A kit comprising a transmitter having a console and at least one programmable sensory feedback switch according to claim 1 disposed on the console, and a receiver associated with the motor controlled device and configured to communicate with the transmitter, the transmitter configured to map the voltage outputs from the programmable sensory feedback switch into the control commands to command selected operations of a motor in the motor controlled device and to send the control commands to the receiver to provide the control commands to the motor controlled device, the switch operational software program executed by the programmable processor being operable to generate the vibration motor control signals based on the control commands transmitted to the receiver.

7. The kit of claim 6, wherein the switch operational software program executed by the programmable processor being operable to generate the vibration motor control signals based also on status of the motor controlled device as indicated in reply signals sent to the transmitter by the receiver.

8. The kit of claim 6 comprising a plurality of console switches comprising a plurality of the programmable sensory feedback switch according to claim 1 disposed on the console.

9. The kit of claim 7, wherein the plurality of console switches are configured to operate respective motor controlled devices.

10. The kit of claim 9, wherein the respective motor controlled devices are deployed on a crane.

11. The kit of claim 9, wherein at least one of the respective motor controlled devices is operable with five speeds, and the switch operational software program executed by the programmable processor is operable to generate the vibration motor control signals to vary according to respective ones of the five speeds as selected via corresponding detected positions of the user moveable control interface.

12. The kit of claim 6 wherein the receiver can transmit reply signals to the transmitter that comprise device data related to the motor controller device chosen from position of the motor controlled device, status of operation of the motor controlled device, speed of movement of the motor controlled device, wherein the switch operational software program executed by the programmable processor is operable to analyze the device data in the reply signals and generate the vibration motor control signals to provide haptic signals that vary in accordance with the device data.

13. The kit of claim 12 wherein the vibration motor operates with increasing intensity of vibration as the motor controlled device reaches a designated positon as indicated in the reply signals.

14. The kit of claim 12 wherein the vibration motor is controlled via the vibration motor control signals to change vibration to indicate that a fault condition has occurred with respect to at least one of the receiver and the motor controlled device, the fault condition chosen from the transmitter and the receiver are not connected, the receiver and/or the motor controlled device has malfunctioned, and the motor controlled device has lost power.

15. The kit of claim 6, wherein the at least one programmable sensory feedback switch according to claim 1 is configured via the switch operational software program executed by the programmable processor to have a user designated number of virtual detents wherein the vibration motor generates a vibrational haptic feedback as the user manipulates the user moveable control interface into a position corresponding to one of the virtual detents.
